(19) United States
(12) Patent Application Publication
(10) Pub. No.: US 2003/0134108 A1
(43) Pub. Date: Jul. 17, 2003

(54) Method of production of veneer assembly

(75) Inventors: Eric Lakatosh, York, PA (US); Robert M. Wigdorski, Red Lion, PA (US); Deepak Hariharan, York, PA (US)

Correspondence Address: BIRCH STEWART KOLASCH & BIRCH, PO BOX 747, FALLS CHURCH, VA, 22040-0747, US

(73) Assignee: Adhesives Research, Inc., Glen Rock, PA

(21) Appl. No.: 10/029,027

(22) Filed: Dec. 28, 2001

(51) Int. Cl. B32B 7/12

(52) U.S. Cl. 428/343

(57) ABSTRACT

A method of production of veneer assemblies is provided wherein an adhesive tape is placed along the joint between adjacent veneer sheets and a core substrate and subjected to heat pressing to bond the veneer to the core substrate.

### BACKGROUND OF THE PRESENT INVENTION

The present invention is directed to a novel method for the preparation of a veneer assembly.

In the furniture industry composite wood panels having veneer surfaces have become commonplace. Such veneer surfaces are formed by the formation of a veneer assembly comprised of thin pieces of veneer, typically of a thickness of 0.03 inches thick or so, adhered to a backing substrate such as particle board. Multiple veneer sheets are placed side-by-side on the backing substrate and bonded to the substrate by the application of heat and/or pressure. Typically, a phenolic or urea formaldehyde adhesive is coated on the backing substrate to bond the veneer to the backing substrate under elevated temperatures and pressure. However, “cold press” conditions may also be employed to bond the veneer to the backing substrate by use of adhesives which activate at temperatures slightly greater than room temperature. In either instance, elevated pressures are employed to press the two layers together.

Conventionally, adhesive tapes are used to bond the exposed joints between adjacent veneer sheets together prior to the bonding step. One type of adhesive tape which has been used to bond the joints has been a non-pressure sensitive adhesive tape having a water-activatable gum on a paper backing. At the conclusion of the bonding step, the tape residue is sanded from the top surface of the veneer.

However, the gum adhesive tends to penetrate the porous surface of the wood veneer, resulting in a discoloration of the surface of the veneer which is undesirable. This necessitates greater sanding effort to remove the offending discoloration. Excessive sanding is to be avoided, however, as the wood veneer industry seeks to use thinner veneers in the manufacturing process.

U.S. Pat. Nos. 5,846,653; 6,048,431; 6,176,957 and 6,187,127 each disclose various attempts to improve the method by which adjacent edges of the veneer sheets are held together by adhesive tape.

One method by which to avoid the need to sand the veneer upon completion of the bonding step would be to place the adhesive between the veneer piece and the substrate to which the veneer is to be bonded. However, this method has not met with success in the past as adhesives conventionally employed tend to flow between the junction between adjacent veneer pieces at the conditions of elevated temperature and pressure used in the bonding step. The thickness of the adhesive also results in telescoping of the wood veneer leaving a raised imprint of the joint type on the top surface.

There exists in the industry sheet goods products that are designed to bond substrates together, i.e., veneer/core board, that are used as overall coverage adhesive sheets. However, these products are not useful for aligning the individual pieces of veneer and transporting the constructed veneer design to the bonding operation. Additionally, if these materials are used in the method of this invention, the thickness of the products not only results in undesirable thickness of the overall bond line but additionally are prohibitively expensive.

It would thus be desirable to provide a method for the production of veneer assemblies which would not be susceptible to such problems.

### OBJECTS AND SUMMARY OF THE PRESENT INVENTION

It is accordingly an object invention to provide an adhesive tape of sufficiently low thickness to permit multiple layers of tape to be used without detrimental effect on the final product and method of use that overcomes the undesirable attributes of previously used material for the veneer assembly market.

In accordance with the present invention, there is provided a method of forming a veneer assembly comprising the steps of:

aligning an edge of a first piece of veneer adjacent an edge of a second piece of veneer to form a junction between the two pieces of veneer, positioning a layer of adhesive optionally in association with a backing layer along at least a portion of said junction between said two pieces of veneer to join said two pieces of veneer together, placing said joined pieces of veneer against a substrate to which said pieces of veneer are to be bonded, and bonding said pieces of veneer to said substrate under conditions of elevated temperature and pressure, and optionally curing said adhesive, whereby the thickness of said adhesive layer together with any backing layer ranges from about 0.0003 to about 0.0050 inches. Desirably, the adhesive layer is comprised of an adhesive which retains its adhesive properties and does not physically degrade under said conditions of elevated temperature and pressure used in the bonding step.

In accordance with the present invention, there is also provided a novel thermally curable pressure sensitive adhesive composition for use in the present invention comprised of:

(1) a pressure sensitive adhesive;

(2) a high Tg acrylic polymer having an epoxy functionality; and

(3) a reactive unsaturated polyester tackifier resin; and

(4) optionally one or more of a crosslinking agent and resinous tackifier.

In a preferred embodiment, the high Tg polymer is comprised of the polymerization reaction product of an alkyl (meth)acrylate monomer having a Tg >20° C. such as t-butyl methacrylate monomer, a C₁₋₃₀ (meth)acrylate monomer such as a C₄₋₁₈ (meth)acrylate monomer, a nitrogen-containing polar monomer such as an N-vinyl lactam monomer, and an epoxy-containing monomer such as a glycidyl monomer.

### DETAILED DESCRIPTION OF THE PRESENT INVENTION

The present invention is directed to the use of adhesive tapes for joining pieces of veneer to be bonded to a substrate, for example, core board. More particularly, the present invention relates to a veneer tape that, after bonding to the substrate, becomes an integral part of the finished assembly.

The method of the present invention overcomes the undesirable attributes of use of prior art materials for the veneer assembly market, in part by use of an adhesive layer optionally in association with a backing material of a thickness sufficiently small as to be used without detrimental effect on the final product. It has been found that the present invention eliminates or minimizes the undesirable sanding operations for tapes and/or adhesive removal on the veneer surface by sandwiching the adhesive between the veneer and the core board substrate. The adhesive used in the present invention preferably will activate and/or not physically degrade to the extent that its adhesive properties become significantly diminished during the heat and pressure bonding step conventionally used in the manufacture of wood furniture and the like and has a service temperature corresponding to those conventionally encountered with respect to the furniture and/or inexpensive products of lesser expected service conditions.

The adhesive used in the method of the present invention is designed to permit preparation of veneer faces whereby the veneer faces are held together during transport of same to the finishing area, and subsequently becomes an integral part of the finished veneer/core assembly when employed with standard adhesives conventionally used in the veneer furniture industry to bond the surface of the veneer to the substrate.

The method of the present invention eliminates the need to remove tape product from the face of the veneer and also minimizes or negates the need to sand the face of the veneer after being bonded to the core board. Although not necessary, it is preferable that the adhesive becomes a structural component of the veneer/core assembly upon heat pressing of same and, more preferably, it is desirable for the adhesive to interact with conventional adhesives used to bond the veneer face to the core.

A variety of adhesives may be used in the adhesive tape used in the present invention. Exemplary adhesives include but are not limited to thermocurable adhesives, water-activatable adhesives, solvent-activatable adhesives, heat-activatable adhesives, radiation-curable adhesives, thermoplastic pressure sensitive adhesives, thermoplastic adhesives, etc. Such adhesives exhibit sufficient “open time” to permit veneer assembly, will not physically degrade during the conditions of the heat pressing step and and exhibit temperature stability at “in service” temperatures up to at least 70° C., and preferably up to at least about 100° C.

Exemples of heat activatable adhesives include but are not limited to polyamide heat activatable adhesives having a softening point of 230° F. and an open time of at least 20 seconds applied at 1 mil thickness, as well as polyurethane adhesives having an activation temperature of at least 115° C. and an open time of equal to or greater than 20 seconds.

Exemples of solvent activatable adhesives include but are not limited to neoprene contact cement (methyl ethyl ketone and/or THF activatable) with an open time of >20 seconds applied at 1 mil thickness or pattern applied at a coverage rate of 18 lbs dry/3000 sq. ft. dry.

Exemples of thermoplastic pressure sensitive adhesives having a service temperature of >100° C. include but are not limited to peroxide cured silicone based pressure sensitive adhesives, poly alpha olefin based adhesives, etc.

Exemples of thermoplastic adhesives can be heat sealed to the surface of the veneer using a heated iron having a service temperature >100° C. and include but are not limited to polyester-based heat seal adhesives, polyvinylidine chloride-based adhesives, polyvinyl chloride-based adhesives, polyurethane-based adhesives, poly alpha olefin based adhesives, etc.

Examples of additional adhesives having a service temperature of equal to or greater than 160° F. include but are not limited to block copolymer-based pressure sensitive adhesives, random copolymer base pressure sensitive adhesives, ethylene vinyl acetate -based adhesives, ethylene butyl acrylate-based adhesives, modified nitrocellulose-based heat seal adhesives, acrylic-based heat seal adhesives, acrylic-based pressure sensitive adhesives, etc.

A preferred thermocurable pressure sensitive adhesive for use in the present invention is comprised of a blend of a pressure sensitive adhesive, a high Tg acrylic copolymer, and a reactive unsaturated polyester tackifier resin.

The base pressure sensitive adhesive used in the preferred thermocurable adhesive composition may comprise a variety of adhesives, including but not limited to tackified natural rubbers, synthetic rubbers, tackified styrene block copolymers, polyvinyl ethers, acrylic adhesives, poly-alpha-olefins, and silicone adhesives.

Natural rubber adhesives generally comprise masticated rubber together with a suitable tackifying resin. Synthetic rubber elastomers are self-tacky, and comprise, for example, butyl rubber, copolymers of isobutylene, polyisobutylene, homopolymers of isoprene, polybutadiene, or styrene/butadiene rubber. Such rubber elastomers may contain a tackifier and/or plasticizer. Styrene block copolymers generally comprise elastomers of the A-B or A-B-A configuration, where A is a thermoplastic polystyrene block and B is a rubbery block of polyisoprene, polybutadiene or poly(ethylene/butylene). Polyvinyl ether pressure sensitive adhesives generally comprise blends of vinyl methyl ether, vinyl ethyl ether or vinyl iso-butyl ether, or homopolymers of vinyl ethers and acrylates. Acrylic pressure sensitive adhesives may comprise, for example, a C₃₋₁₂ alkyl ester component and a polar component such as (meth)acrylic acid, N-vinyl pyrrolidone, etc. Such adhesives may be tackified. Poly-alpha-olefins adhesives comprise an optionally crosslinked C₃₋₁₈ poly(alkene) polymer, which is either self-tacky or may include a tackifier. Silicone pressure sensitive adhesives comprise a polymer or gum constituent and a tackifying resin.

Such pressure sensitive adhesives are well known to one of ordinary skill in the art and may be easily selected by such persons for use in the present invention.

The high Tg acrylic copolymer of the present invention is comprised of the polymerization reaction product of an alkyl (meth)acrylate monomer having a Tg >20° C., optionally a C₁₋₃₀ (meth)acrylate monomer, a nitrogen-containing polar monomer, and an epoxy-containing monomer, each as defined below. The monomers are present in an amount such that the Tg of the resulting polymer is greater than 50° C.

The alkyl (meth)acrylate monomer having a Tg>20° C. may be selected from but not limited to the group consisting of t-butyl(meth)acrylate, hexadecyl acrylate, isobomyl (meth)acrylate, cyclododecyl acrylate, methyl methacrylate, secondary butyl methacrylate, ethyl methacrylate, cyclohexyl methacrylate and mixtures thereof.

The optional C₁₋₃₀ (meth)acrylate monomer used in the high Tg polymer of the present invention may comprise a monomeric (meth)acrylic acid ester of a non-tertiary alcohol wherein the alcohol portion has from 4 to 18 carbon atoms. Exemplary (meth)acrylate monomers include but are not limited to esters of (meth)acrylic acid with non-tertiary alcohols such as 1-butanol, 1-pentanol, 2-pentanol, 3-pentanol, 2-methyl-1-butanol, 1-methyl-pentanol, 2-methyl-1-pentanol, 3-methyl-1-pentanol, 2-ethyl-1-butanol, 3,5,5-trimethyl-1-hexanol, 3-heptanol, 2-octanol, 1-decanol, 1-dodecanol, etc.

Exemplary monomeric (meth)acrylate monomers having a carbon chain of at least 12 carbon atoms include but are not limited to lauryl acrylate (C₁₂), tridecylacrylate (C₁₃), myristyl acrylate (C₁₄), palmityl acrylate (C₁₆) and stearyl acrylate (C₁₈). Such monomers are well-known to those skilled in the art.

The at least one nitrogen-containing polar monomer used in the high Tg polymer may be selected from a wide range of suitable monomers. Such monomers include, for example, vinyl monomers having at least one nitrogen atom. Such monomers include but are not limited to N-mono-substituted acrylamides, such as a (meth)acrylamide, N-methylacrylamide, N-ethylacrylamide, N-methylolacrylamide, N-hydroxyethylacrylamide and diacetone acrylamide; N,N-disubstituted acrylamides such as N,N-dimethylacrylamide, N,N-diethylacrylamide, N-ethyl-N-aminoethylacrylamide, N-ethyl-N-hydroethylacrylamide, N,N-dimethylolacrylamide, and N,N-dihydroxyethylacrylamide, etc.

Exemplary nitrogen-containing monomers may also include but are not limited to N-vinyl lactam monomers such as N-vinyl-2-pyrrolidone, 5-methyl-N-vinyl-2-pyrrolidone, 5-ethyl-N-vinyl-2-pyrrolidone, 3,3-dimethyl-N-vinyl-2-pyrrolidone, 3-methyl-N-vinyl-2-pyrrolidone, 3-ethyl-N-vinyl-2-pyrrolidone; 4-methol-N-vinyl-2-pyrrolidone; 4-ethyl-N-vinyl-2-pyrrolidone; N-vinyl-2-valerolactam; N-vinyl-2-caprolactam; N-vinyl-2-piperidone; and N,N-dimethylacrylamide and mixtures of any of the foregoing. The corresponding allyl derivatives thereof are also suitable for use in the present invention. The noted lactams may also be substituted in the lactam ring by one or more lower alkyl groups having from 1 to 4 carbon atoms, with methyl, ethyl, or propyl groups being particularly preferred. The N-vinyl lactam monomer employed preferably comprises N-vinyl-2-pyrrolidone.

The polymerizable epoxy-containing monomer may be selected from a variety of vinyl-terminated epoxy-containing monomers. Exemplary polymerizable monomers include but are not limited to glycidyl esters of an α,β-ethylenically unsaturated carboxylic acid, such as (meth)acrylic or crotonoic acid.

Exemplary glycidyl monomers for use in the present invention accordingly include but are not limited to glycidyl (meth)acrylate, glycidyl ethacrylate and glycidyl itaconate, acryl glycidyl ether, (meth)allyl glycidyl ether and 3,4-epoxy-1-vinylcyclohexane.

The alkyl (meth)acrylate monomer is present in the copolymerizable reactant mixture used to form the high Tg polymer in an amount ranging from about 20 to 80 percent by weight, the polymerizable C₁ 30 (meth)acrylate monomer is present in the mixture in an amount ranging from about 0 to 50 percent by weight, the nitrogen-containing polar monomer is present in the mixture in an amount ranging from about 5 to 50 percent by weight, and the polymerizable epoxy-containing monomer is present in the mixture in an amount ranging from about 5 to 50 percent by weight. The epoxy-containing monomer is preferably present in an amount greater than 15 percent by weight.

The alkyl (meth)methacrylate monomer is present together with the nitrogen-containing monomer in an amount such that the resulting copolymer exhibits a Tg>50° C., and preferably at least 60° C. The polymer does not exhibit pressure sensitive adhesive properties. However, the polymer will exhibit adhesive properties upon being admixed with the base adhesive and the reactive unsaturated polyester tackifier.

The high Tg polymer can be prepared by any suitable reaction technique such as free radical initiation techniques in the presence of a solvent. Exemplary solvents include but are not limited to ethyl acetate, ketones, cyclohexane, or mixtures thereof. Solids content during polymerization may typically range from about 40% to 60%. Exemplary free radical initiators include but are not limited to peresters, acyl peroxides and those of the azo type, such as 2,2′-azobis(isobutyronitrile), benzoyl peroxide, lauroyl peroxide, t-butyl perbenzoate, t-butyl peroxypivalate, dibenzyl peroxydicarbonate, and diisopropyl peroxydicarbonate. Ultraviolet light and ionizing radiation may also be employed. The free radical initiator is generally present in the reaction mixture in an amount ranging from 0.01 to 10% by wt. based on the total weight of the monomers in the reaction mixture.

Typical polymerization temperatures range from 20° C. to 150° C. for periods of time of from 2 to 24 hours until the desired degree of conversion occurs. The resulting polymer will preferably exhibit a molecular weight in the range of 50,000 to 2,000,000 and be substantially non-tacky in nature.

U.S. Pat. No. 6,200,639 discloses at column 8, lines 25-36 a copolymer of glycidyl methacrylate and t-butyl methacrylate, optionally in association with an aromatic vinyl-functional monomer, one or more hydroxyl-functional (meth)acrylic monomers and one or more additional monomers.

U.S. Pat. No. 5,723,191 discloses a tackified dual cure pressure sensitive adhesive comprised of a copolymer having an acrylic backbone, a glycidyl monomer, an unsaturated carboxylic acid monomer, and a vinyl lactam monomer, together with a tackifier.

U.S. Pat. No. 3,787,380 discloses a copolymer of N-vinyl or N-allyl heterocyclic monomers, and unsaturated ester monomer and a glycidyl monomer.

U.S. Pat. Nos. 4,812,541 and 5,639,811 disclose a pressure sensitive adhesive copolymer comprised of a N-vinyl lactam monomer, a glycidyl monomer and an alkyl (meth)acrylate monomer.

U.S. Pat. No. 5,270,416 discloses a thermosetting powder comprised of a glycidyl monomer, a methyl (meth)acrylate, butyl acrylate and styrene.

U.S. Pat. No. 3,857,905 discloses a thermosetting coating composition comprised of a glycidyl monomer, a lower alkyl acrylate and a methyl acrylate.

In order to form a thermocurable pressure sensitive adhesive, the high Tg polymer is blended with the base pressure sensitive adhesive and the reactive unsaturated polyester tackifier resin to yield a blend having pressure sensitive adhesive properties.

The reactive unsaturated polyester tackifier resin may be selected from any number of conventional resins known to those of ordinary skill in the art. The unsaturated polyester resin is a condensation reaction product of an unsaturated polycarboxylic acid and a polyol and generally has an average molecular weight of from about 500 to about 10,000, and preferably from about 1,000 to about 6,000. The polyesters also generally have an acid number of less than 100, preferably ranging from about 10 to about 70.

Exemplary unsaturated polyester tackifier resins are those defined by the formula CnH₂ₙ₋₂ (COOH)₂ wherein n is an integer of from 2 to 20.

Exemplary acids which can be used to form the polyester include but are not limited to fumaric, maleic, glutaconic, citraconic, itaconic, mesaconic, allymalonic, propylidenemalonic, hydromuconic, pyrocinchonic, ally succinic, teraconic, xeronic and other like ethylenically unsaturated acids. The corresponding anhydrides of the above acids can also be used in the formation of the unsaturated polyesters.

Exemplary polyols which may be used in the production of the polyester include but are not limited to ethylene glycol, diethylene glycol, propylene glycol, dipropylene glycol, 1,3-butanediol, 2,3-butanediol, neopentyl glycol, etc.

The manner of preparation of the unsaturated polyester is known to those of ordinary skill in the art. Typically, the condensation reaction occurs by reacting a mixture comprised of the unsaturated carboxylic acid and the polyol at temperatures ranging from about 160° C. to about 250° C. The polyol is preferably present in molar excess to the acid so as to produce a polyester having the desired acid number.

Such unsaturated polyesters and the method of production of same are disclosed in U.S. Pat. No. Re 31,975; 5,098,950; 3,700,624; and 4,654,233, each herein incorporated by reference.

The base pressure sensitive adhesive, the high Tg polymer and the unsaturated polyester tackifier are blended together by any suitable means such as mechanical mixing using a propeller-type mixing blade.

The blended composition may also comprise a crosslinking agent to assist in the thermocuring of the composition during the heat pressing step. Exemplary crosslinking agents are disclosed in U.S. Pat. Nos. 3,714,096; 3,923,931; 4,454,301; 4,950,708; 5,194,486; 5,214,094; 5,420,195; and 5,563,205, each herein incorporated by reference. Exemplary crosslinking agents include polyfunctional compounds having at least two non-conjugated carbon-to-carbon double bonds. Exemplary polyfunctional compounds include but are not limited to diallyl maleate, diallyl phthalate, and multi-functional acrylates and methacrylates (such as polyethylene glycol diacrylate, hexane diol diacrylate, ethoxylated trimethylolpropane triacrylate, pentaerythritol triacrylate, propylene glycol diacrylate and trimethylolpropane trimethylacrylate). Such crosslinking agents are disclosed in U.S. Pat. Nos. 5,420,195 and 5,563,205, each herein incorporated by reference.

By way of specific example, suitable crosslinking agents which may be employed include the following:

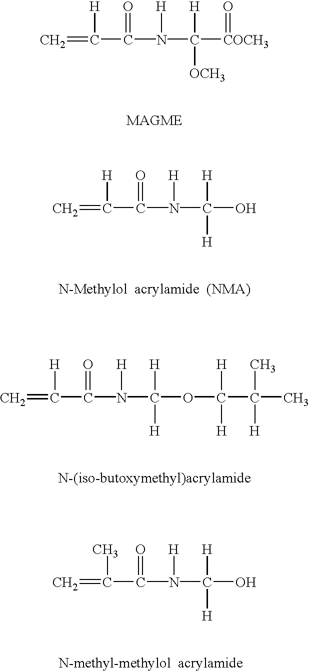

IBMA

Combinations of the above crosslinking compounds may also be employed.

A curing agent having a sufficiently low activation temperature such that the blend may be thermocured at a temperature sufficiently within the thermal pressing temperature range used during the veneer manufacturing process. Exemplary curing agents dicyanamides, imidazoles, ketamines, modified amines and substituted ureas, dicarboxylic acids, mercaptans, acid anhydrides, dihidrizide compounds, polyfunctional amines, cationic UV cure photoinitiators, peroxides and azo compounds.

The above novel thermocurable adhesive composition may be coated onto a backing material by any conventional manner, such as by roll coating, spray coating, or extrusion coating, etc. by use of conventional extrusion devices. As discussed above, the composition may be coated either with or without a solvent, with the solvent subsequently removed to leave the tacky adhesive layer on the backing material. Typically, the blend will comprise about 40% by wt. solids.

The thermocurable adhesive composition will comprise from about 15 to about 70 percent by weight of the pressure sensitive adhesive component, from about 0.01 to about 45 percent by weight of the high Tg polymer, from about 5 to about 45 percent by weight of the unsaturated polyester, and optionally from about 0.01 to about 30 percent by weight of the crosslinking agent.

The thermocurable adhesive composition may optionally include a resinous tackifier. Such tackifiers include but are not limited to aromatic/aliphatic resins, C₅₋₉ hydrocarbon resins, rosin esters, terpene esters, wood rosin and esters thereof, gum resins, deliminine resins, curoendene resins, or other tackifiers conventionally used in pressure sensitive adhesives. Such tackifiers can be present in an amount ranging from 0 to 45% by weight.

In the method of the present invention, the adhesive may be employed to bond adjacent pieces of veneer together with or without a backing layer.

Exemplary backing materials which may be employed in connection with the adhesive during practice of the method of the present invention include but are not limited to flexible and inflexible backing materials conventionally employed in connection with pressure sensitive adhesives. Such materials include creped paper, kraft paper, fabrics, impregnated paper such as a phenolic or urea formaldehyde resin, adhesive fabrics, (knits, non-wovens, wovens), foil and synthetic polymer films such as polyethylene, polypropylene, polyvinyl chloride, poly(ethylene terephthalate), and cellulose acetate, polyurethane films, rubber phenolic films, as well as glass, ceramics, metallized polymer films and other composite sheet materials, or other carriers that will react with the adhesives used to bond the veneer to the basecore. In another embodiment, the adhesive may be applied between two transfer films to form a transfer adhesive, in which case the adhesive film would be employed in the absence of a backing layer.

If heat curable, the adhesive layer will be cured during the heat pressing step upon formation of the veneer assembly. If non-heat curable, the adhesive may be cured subsequent to the heat pressing step. Such curing will enhance the structural integrity of the bond between the pieces of veneer and the substrate, but such curing is not necessary to practice of the present invention as long as adequate adhesive is obtained subsequent to the heat pressing step.

The method of the present invention adhesive tape of the present invention may be practiced as follows in the production of a veneer assembly comprised of a veneer sheet and a backing (or core) substrate.

In accordance with the present invention, an adhesive tape is placed in overlapping relationship along at least a portion of the joint defined by adjacent edges of veneer sheets at the bottom surface of the veneer sheets (i.e., the surface facing the top portion of the backing substrate). The adhesive enhances the bond between the joints of the veneer as well as the quality of the finished product.

The core or backing substrate is generally coated with an adhesive such as a phenolic or urea formaldehyde adhesive. The adjacent edges of the veneer sheets are held together by application of the adhesive in overlapping relationship to at least a portion of the joint between the adjacent veneer sheets on the bottom surface of the veneer. The thus-formed veneer assembly is then subjected to appropriate conditions of temperature and pressure in order to bond the veneer to the backing substrate. Typical conditions of temperature and pressure used in the bonding step include a temperature of from 200-450° F. and a pressure of from 75-500 psi. The bonding step generally occurs over a period of time ranging from 30 seconds to 10 minutes.

The thickness of the adhesive used in the bonding step together with any backing layer which may be present will range from about 0.0003 to about 0.0050 inches, and preferably from about 0.0005 to about 0.0020 inches, in order to reduce the occurrence of “telescoping” during the formation of the veneer assembly.

The present invention is illustrated by the following Examples which are intended to be merely illustrative in nature and not limiting in scope.

### EXAMPLE 1

The high Tg acrylic polymer component used in the preferred thermocurable adhesive of the present invention (comprised of 40% by wt. t-butyl methacrylate, 10% by wt. butyl acrylate, 20% by wt. N-vinyl-2-pyrrolidone and 30% by wt.glycidyl methacrylate) was formed in ethyl acetate solvent using a free radical initiator to a molecular weight of approximately 200,000 GPC relative to polystyrene and having a first pass glass transition temperature (Tg) of about +60° C. DSC and a second pass glass transition temperature (Tg) of approximately +90° C. DSC.

### EXAMPLE 2

A thermocurable pressure sensitive adhesive composition suitable for use in the present invention was formed in the following manner. A base pressure sensitive adhesive marketed by Ashland under the designation A1044 (comprised of a vinyl acetate modified acrylate pressure sensitive adhesive containing an acid functionality) was admixed with the high Tg polymer of Example 1 comprised of the reaction product of 40% by wt. t-butyl methacrylate, 10% by wt. butyl acrylate, 20% by wt. N-vinyl-2-pyrrolidone and 30% by wt. glycidyl methacrylate) and a reactive unsaturated polyester tackifier resin together with a dipropylene glycol diacrylate crosslinking agent (Laromer UP 35D). A free radical initiator was also present, being either a peroxide or azo initiator. The resulting adhesive composition in the form of a 1 mil thickness film exhibits 1-4 lbs/inch of peel adhesion, and holds 500 grams in a static shear for 30-2000 minutes.

### EXAMPLE 3

The pressure sensitive adhesive of Example 2 was transfer coated onto a phenolic modified elastomer coated paper and used to join adjacent pieces of veneer together by application to the joint between the adjacent pieces along the bottom surface of the veneer. Upon removal of the paper, the combination of the phenolic modified elastomer coating and the adhesive had sufficient strength to hold the veneer pieces together during subsequent handling. The veneer, with the phenolic modified elastomer/thermosetting resin, was bonded to particle board core using a urea formaldehyde adhesive commonly used in the industry, such that the veneer joint adhesive tape was sandwiched between the core and the veneer face. When pressed between the pieces of veneer at 250° F. and 150 psi for 120 seconds, the resulting pieces of veneer are bonded together, exhibiting acceptable performance and no telescoping of the face of the veneer was observed.

### EXAMPLE 4

A water activatable urea formaldehyde modified polyvinyl alcohol adhesive was coated onto a porous paper, thus saturating the paper. After contacting the adhesive saturated paper with a water-soaked sponge, the adhesive became tacky and had sufficient strength to hold the veneer pieces together during subsequent handling. The veneer was then pressed as in Example 3 with the water-activatable adhesive tape being sandwiched between the veneer and core along the joint between the adjacent veneer pieces. The resulting pieces were bonded together, exhibiting acceptable performance and show no sign of telescoping of the face of the veneer in all areas including multiple tape layer areas.

### EXAMPLE 5

A water activatable adhesive tape suitable for use in the present invention was prepared as follows. Urea formaldehyde resin (65% solids in water) that is crosslinkable with di- or trivalent metal catalyst such as aluminum trichloride was blended with 30% water solution of partially hydrolyzed polyvinyl alcohol to obtain a 1:1 ratio of urea formaldehyde resin to polyvinyl alcohol on a dry solids basis. The combination was applied to 8# tissue paper to achieve a dry adhesive application coating weight of 0.7 oz/square yd. The adhesive coated tissue was dried at 104° C. for 5 minutes to drive off water in the adhesive. The adhesive coated tissue was essentially non-tacky after drying. The adhesive tape was tested for dynamic shear and veneer assembly.

The adhesive tape described above was water activated by passing the adhesive coated tape over a wet sponge and then bonding the tape to a 2 inch×1 inch×¼ inch thick piece of furniture grade oak such that a one square inch area of wood was covered with the tape. After 1 hour drying time, the first piece of oak was then heat bonded to a second piece of oak of equal dimensions with a conventional two package urea formaldehyde veneer assembly adhesive (Casco 583 plus catalyst) applied at a spread rate of approximately 25 lbs./1000 sq. ft. wet (approximately 0.006 inches thick) under a pressure of approximately 75 psi for 5 minutes at 120° C. such that the adhesive tape was sandwiched between the two pieces of oak whereby a lap shear bond of 1 sq. in. was formed. After a cool-down to room temperature, the protruding one inch ends of the lap shear construction were clamped between the jaws of an Instron model number 4201 tensile tester and evaluated for dynamic shear strength at a jaw separation rate of 0.5 inch/minute. In the case where more than one layer of tape was used, the additional layers of tape were placed in an orientation of “adhesive coated surface” to “carrier surface” after water activation such that the tapes were stacked upon each other. Once stacked and dried the second piece of oak was bonded in the same manner as the single layer tape construction. Testing of the final construction was performed in the same manner as the single tape layer construction.

Dynamic shear data for 1, 2 and 4 layers of adhesive tape bonded between wood surfaces using conventional urea formaldehyde adhesive used in the furniture making operation is the following:

| | | |
|---|---|---|
| 1 tape layer | <200 psi | Exceeds load cell capability |
| 2 tape layers | >190 psi | Exceeds load cell capability |
| 4 tape layers | >190 psi | Exceeds load cell capability |

The adhesive of this example was applied to 20 lb. porous paper to achieve a dry adhesive coating weight of 0.7 oz./sq. yd. and dried for 5 minutes at 104° C. to remove the water. The tape was essentially non-tacky when dry. The tape was water activated by passing the adhesive over a wet brush commonly found on manual and automatic wet gum tape dispensers. The water activatable tape was used to construct a veneer face of cherry wood veneer using up to 5 layers of tape in various areas. The finished veneer face was transported to the laminating area without special precautions. The veneer face was bonded to a particle board core using Casco 583 urea formaldehyde adhesive containing catalyst at a spread rate of approximately 25 wet pounds/1000 sq. ft. with the tape sandwiched between the veneer and the core board while heat pressing at approximately 149° C. for 4 minutes at 100 psi while the Casco 583 was still wet. The resulting laminated construction showed no sign of telescoping through the veneer face with structural performance. Structural performance is defined as component destroying bonds when the veneer face and core board were attempted to be separated.

Although a 1:1 ratio of urea formaldehyde:polyvinyl alcohol on a dry basis is demonstrated in the example, higher and lower concentration of each component were evaluated with similar results. Additionally, various hydrolyzation levels of polyvinyl alcohol function as long as the hydrolyzation level is such that it permits the polyvinyl alcohol to water activate.

What is claimed is:

1. A method of forming a veneer assembly comprising the steps of:
aligning an edge of a first piece of veneer adjacent an edge of a second piece of veneer to form a junction between the two pieces of veneer, positioning a layer of adhesive along at least a portion of said junction between said two pieces of veneer to join said two pieces of veneer together, placing said joined pieces of veneer against a substrate to which said pieces of veneer are to be bonded whereby said adhesive layer is positioned between said pieces of veneer and said substrate, and bonding said pieces of veneer to said substrate under conditions of elevated temperature and pressure, whereby the thickness of said adhesive layer ranges together with any backing layer that may be present on the adhesive ranges from about 0.0003 to about 0.0050 inches.

2. The method of claim 1 wherein said adhesive is selected from the group consisting of thermocurable adhesives, water-activatable adhesives, solvent-activatable adhesives, heat-activatable adhesives, radiaton-curable adhesives, thermoplastic pressure sensitive adhesives, and thermoplastic adhesives.

3. The method of claim 1 wherein said adhesive is a pressure sensitive adhesive comprised of:
(1) a pressure sensitive adhesive;
(2) a polymer having a Tg>50° C. comprised of the polymerization reaction product of the following monomers:
an alkyl (meth)acrylate monomer having a Tg>20° C.;
a C₁₋₃₀ (meth)acrylate monomer;
a nitrogen-containing polar monomer; and
a polymerizable epoxy-containing monomer,
said monomers being present in an amount such that the Tg of said polymer is greater than 50° C., and
(3) a reactive unsaturated polyester tackifier resin.

4. The method of claim 3 wherein said nitrogen-containing monomer is selected from the group consisting of vinyl monomers having at least one nitrogen atom and N-vinyl lactam monomers.

5. The method of claim 3 wherein said an N-vinyl lactam monomer is selected from the group consisting of N-vinyl-2-pyrrolidone, 5-methyl-N-vinyl-2-pyrrolidone, 5-ethyl-N-vinyl-2-pyrrolidone, 3,3-dimethyl-N-vinyl-2-pyrrolidone, 3-methyl-N-vinyl-2-pyrrolidone, 3-ethyl-N-vinyl-2-pyrrolidone; 4-methol-N-vinyl-2-pyrrolidone; 4-ethyl-N-vinyl-2-pyrrolidone; N-vinyl-2-valerolactam; N-vinyl-2-caprolactam; N-vinyl-2-piperidone; N,N-dimethylacrylamide and mixtures thereof.

6. The method of claim 3 wherein said C₁₋₃₀ (meth)acrylate monomer is an ester of (meth)acrylic acid with a non-tertiary alcohol selected from the group consisting of 1-butanol, 1-pentanol, 2-pentanol, 3-pentanol, 2-methyl-1-butanol, 1-methyl-pentanol, 2-methyl-1-pentanol, 3-methyl-1-pentanol, 2-ethyl-1-butanol, 3,5,5-trimethyl-1-hexanol, 3-heptanol, 2-octanol, 1-decanol, 1-dodecanol and octadecanol.

7. The method of claim 3 wherein said alkyl (meth)acrylate monomer having a Tg>20° C. is selected from the group consisting of t-butyl(meth)acrylate, hexadecyl acrylate, isobomyl (meth)acrylate, cyclododecyl acrylate, methyl methacrylate, secondary butyl methacrylate, ethyl methacrylate, cyclohexyl methacrylate and mixtures thereof.

8. The method of claim 3 wherein said epoxy resin comprises a glycidyl monomer.

9. The method of claim 3 wherein the Tg of said polymer is at least 60° C.

10. The method of claim 3 wherein said alkyl (meth)acrylate is present in said polymer in an amount ranging from about 20 to 80 about percent by weight.

11. The method of claim 3 wherein said C₁₋₃₀ (meth)acrylate monomer is present in said polymer in an amount ranging from 0 to about 50 percent by weight.

12. The tape of claim 3 wherein said epoxy-containing monomer is present in said polymer in an amount ranging from about 5 to about 50 percent by weight.

13. The method of claim 3 wherein said nitrogen-containing monomer is present in said polymer in an amount ranging from about 5 to about 50 percent by weight.

14. The method of claim 3 further comprising a crosslinking agent.

15. The method of claim 14 wherein said crosslinking agent is selected from the group consisting of diallyl maleate, diallyl phthal ate, and multi-functional acrylates and methacrylates (such as polyethylene glycol diacrylate, hexane diol diacrylate, ethoxylated trimethylolpropane triacrylate, pentaerythritol triacrylate, propylene glycol diacrylate, trimethylolpropane trimethylacrylate and mixtures thereof.

16. The method of claim 3 wherein said composition comprises from about 15 to about 70 percent by weight of the pressure sensitive adhesive component, from about 0.01 to about 45 percent by weight of the high Tg polymer, from about 5 to about 40 percent by weight of the unsaturated polyester, and optionally from about 0.01 to about 30 percent by weight of the crosslinking agent.

17. The method of claim 1 wherein said bonding step includes a pressure within the range of from 75-500 psi.

18. The method of claim 1 wherein said bonding step includes a temperature within the range of from 200-450° F.

19. A thermocurable pressure sensitive adhesive composition comprised of:
(1) a pressure sensitive adhesive;
(2) a polymer having a Tg>50° C. comprised of the polymerization reaction product of the following monomers:
an alkyl (meth)acrylate monomer having a Tg>20° C.;
a C₁₋₃₀ (meth)acrylate monomer;
a nitrogen-containing polar monomer; and
a polymerizable epoxy-containing monomer,
said monomers being present in an amount such that the Tg of said polymer is greater than 50° C., and
(3) a reactive unsaturated polyester tackifier resin.

20. The composition of claim 19 wherein said nitrogen-containing monomer is selected from the group consisting of vinyl monomers having at least one nitrogen atom and N-vinyl lactam monomers.

21. The composition of claim 19 wherein said an N-vinyl lactam monomer is selected from the group consisting of N-vinyl-2-pyrrolidone, 5-methyl-N-vinyl-2-pyrrolidone, 5-ethyl-N-vinyl-2-pyrrolidone, 3,3-dimethyl-N-vinyl-2-pyrrolidone, 3-methyl-N-vinyl-2-pyrrolidone, 3-ethyl-N-vinyl-2-pyrrolidone; 4-methol-N-vinyl-2-pyrrolidone; 4-ethyl-N-vinyl-2-pyrrolidone; N-vinyl-2-valerolactam; N-vinyl-2-caprolactam; N-vinyl-2-piperidone; N,N-dimethylacrylamide and mixtures thereof.

22. The composition of claim 19 wherein said C₁₋₃₀ (meth)acrylate monomer is an ester of (meth)acrylic acid with a non-tertiary alcohol selected from the group consisting of 1-butanol, 1-pentanol, 2-pentanol, 3-pentanol, 2-methyl-1-butanol, 1-methyl-pentanol, 2-methyl-1-pentanol, 3-methyl-1-pentanol, 2-ethyl-1-butanol, 3,5,5-trimethyl-1-hexanol, 3-heptanol, 2-octanol, 1-decanol, 1-dodecanol and octadecanol.

23. The composition of claim 19 wherein said alkyl (meth)acrylate monomer having a Tg>20° C. is selected from the group consisting of t-butyl(meth)acrylate, hexadecyl acrylate, isobomyl (meth)acrylate, cyclododecyl acrylate, methyl methacrylate, secondary butyl methacrylate, ethyl methacrylate, cyclohexyl methacrylate and mixtures thereof.

24. The composition of claim 19 wherein said epoxy resin comprises a glycidyl monomer.

25. The composition of claim 19 wherein the Tg of said polymer is at least 60° C.

26. The composition of claim 19 wherein said alkyl (meth)acrylate is present in said polymer in an amount ranging from about 20 to 80 about percent by weight.

27. The composition of claim 19 wherein said C₁₋₃₀ (meth)acrylate monomer is present in said polymer in an amount ranging from 0 to about 50 percent by weight.

28. The composition of claim 19 wherein said epoxy-containing monomer is present in said polymer in an amount ranging from about 5 to about 50 percent by weight.

29. The composition of claim 19 wherein said nitrogen-containing monomer is present in said polymer in an amount ranging from about 5 to about 50 percent by weight.

30. The composition of claim 19 further comprising a crosslinking agent.

31. The composition of claim 30 wherein said crosslinking agent is selected from the group consisting of diallyl maleate, diallyl phthalate, and multi-functional acrylates and methacrylates (such as polyethylene glycol diacrylate, hexane diol diacrylate, ethoxylated trimethylolpropane triacrylate, pentaerythritol triacrylate, propylene glycol diacrylate, trimethylolpropane trimethylacrylate and mixtures thereof.

32. The composition of claim 30 wherein said composition comprises from about 15 to about 70 percent by weight of the pressure sensitive adhesive component, from about 0.01 to about 45 percent by weight of the high Tg polymer, from about 5 to about 40 percent by weight of the unsaturated polyester, optionally from about 0.01 to about 30 percent by weight of the crosslinking agent, and from about 0 to 45 percent by weight of a resinous tackifier.

33. An adhesive tape comprised of a backing layer and the adhesive composition of claim 19.
